(19) United States
(12) Patent Application Publication
(10) Pub. No.: US 2023/0269699 A1
(43) Pub. Date: Aug. 24, 2023

(54) VEHICLE LOCATION SHARING METHOD, SYSTEM AND APPARATUS, DEVICE, MEDIUM, AND PROGRAM PRODUCT

(71) Applicant: Tencent Technology (Shenzhen) Company Limited, Shenzhen (CN)

(72) Inventors: Xun SUN, Shenzhen (CN); Xiaotao LI, Shenzhen (CN); Weibo LIN, Shenzhen (CN); Bosheng CHEN, Shenzhen (CN); Junchen LIU, Shenzhen (CN)

(73) Assignee: Tencent Technology (Shenzhen) Company Limited, Shenzhen (CN)

(21) Appl. No.: 18/307,414

(22) Filed: Apr. 26, 2023

Related U.S. Application Data
(63) Continuation of application No. PCT/CN2022/107664, filed on Jul. 25, 2022.

(30) Foreign Application Priority Data
Aug. 20, 2021 (CN) 202110961362.7

(51) Int. Cl. H04W 64/00; H04L 51/52

(52) U.S. Cl. CPC H04W 64/003; H04L 51/52

(57) ABSTRACT

A vehicle location sharing method enables real-time location sharing of the vehicle that can improve the safety of a user driving the vehicle. A function interface is displayed that provides a location function. A trigger operation is received on the location sharing function, and a candidate account list is displayed based on the trigger application. The candidate account list includes a candidate account that has an association relationship with a first account. A selection operation is received on a second account and a a location sharing result is displayed in response to the selection operation. This provides a convenient operation to share location information without use of cumbersome operations, such as through the use of a mobile phone.

### RELATED APPLICATION

This application claims priority as a continuation of PCT/CN2022/107664, filed Jul. 25, 2022, published as WO2023/020207, and entitled “VEHICLE LOCATION SHARING METHOD, SYSTEM, APPARATUS AND DEVICE, MEDIUM, AND PROGRAM PRODUCT” which claims priority to Chinese Patent Application No. 202110961362.7, filed on Aug. 20, 2021 entitled “VEHICLE LOCATION SHARING METHOD, SYSTEM AND APPARATUS, DEVICE, MEDIUM, AND PROGRAM PRODUCT,” each of which are hereby incorporated herein by reference in their entirety.

### FIELD OF THE TECHNOLOGY

This disclosure relates to the field of human-computer interaction, and in particular, to a vehicle location sharing method, system and apparatus, a device, a medium, and a program product.

### BACKGROUND OF THE DISCLOSURE

Vehicles have become widespread and in-vehicle terminals have become standard configurations of most vehicles, providing a level of convenience for travel. There are cases where vehicle location sharing is beneficial.

Some vehicle generate a sharing code through an in-vehicle terminal and a user uses a mobile phone to inform another person of the sharing code, and the person uses a corresponding mobile phone application to input the sharing code and can access the user vehicle location.

However, when driving the vehicle, the user likely cannot use their mobile phone to perform cumbersome operations to share their location because doing so poses a great danger to driver safety.

### SUMMARY

This disclosure provides a vehicle location sharing method, system and apparatus, a device, a medium, and a program product, which can improve the convenience of real-time vehicle location sharing and improve the safety of a user when driving a vehicle.

In some examples, a vehicle location sharing method is provided. The method includes:
displaying a function interface, the function interface being used for providing a location sharing function;
receiving a trigger operation on the location sharing function;
displaying a candidate account list based on the trigger operation, the candidate account list including at least one candidate account having an association relationship with a first account, and the first account being an account logging in the in-vehicle terminal; and
displaying a location sharing result in response to receiving a selection operation on a second account in the at least one candidate account, the location sharing result including a result of sharing geographical location information of the in-vehicle terminal from the first account to the second account.

In some examples, a vehicle location sharing system is provided. The vehicle location sharing system includes a first terminal and a second terminal. The first terminal is an in-vehicle terminal. A first account logs in the first terminal, a second account logs in the second terminal, and the first account has an association relationship with the second account.

The first terminal is configured to: display a function interface, the function interface being used for providing a location sharing function; display a candidate account list in response to a trigger operation on the location sharing function, the candidate account list including the second account; receive a selection operation on the second account; and transmit a location sharing message to the second account.

The second terminal is configured to: receive the location sharing message transmitted by the first account; receive a message trigger operation on the location sharing message; and display geographical location information of the first terminal based on the message trigger operation on the location sharing message.

The first terminal is further configured to display a location sharing result based on the message trigger operation on the location sharing message by the second account.

In some examples, a vehicle location sharing apparatus is provided. The apparatus includes:
a function display module, configured to displaying a function interface, the function interface being used for providing a location sharing function;
a receiving module, configured to receive a trigger operation on the location sharing function;
a list display module, configured to display a candidate account list based on the trigger operation, the candidate account list including at least one candidate account having an association relationship with a first account; and
a result display module, configured to display a location sharing result in response to receiving a selection operation on a second account in the at least one candidate account, the location sharing result including a result of sharing geographical location information of the in-vehicle terminal from the first account to the second account.

In some examples, a computer device is provided. The computer device includes a processor and a memory. The memory stores at least one instruction, at least one program, a code set, or an instruction set. The at least one instruction, the at least one program, the code set, or the instruction set is loaded and executed by the processor to implement the vehicle location sharing method.

In some examples, a non-transitory computer-readable storage medium is provided. The storage medium stores at least one instruction, at least one program, a code set, or an instruction set. The at least one instruction, the at least one program, the code set, or the instruction set is loaded and executed by a processor to implement the vehicle location sharing method.

In some examples, a computer program product or a computer program is provided. The computer program product or the computer program includes computer instructions. The computer instructions are stored in a non-transitory computer-readable storage medium. A processor of a computer device reads the computer instructions from the non-transitory computer-readable storage medium. The processor executes the computer instructions, so as to enable the computer device to perform a vehicle location sharing method.

A location sharing function is provided on an in-vehicle terminal. When the location sharing function is triggered, a candidate account list is displayed, and a second account selected to perform location sharing is determined on the basis of the candidate account list, so as to complete a location sharing process of a first account through a convenient operation, thereby completing location sharing without mobile phone-based cumbersome operations during a driving process, improving the driving safety of the location sharing process, and improving location sharing efficiency by using the in-vehicle terminal. In the meantime, since the location sharing process can be completed without a sharing code through an additional terminal, the data interaction between different terminals is reduced, and the security of information in the location sharing process can be improved. That is to say, the problem of location information leakage caused by the sharing code being maliciously propagated is avoided.

### BRIEF DESCRIPTION OF THE DRAWINGS

FIG. 1 is a schematic diagram of an example vehicle location sharing environment according to some embodiments.

FIG. 2 is a flowchart of an example vehicle location sharing method according to some embodiments.

FIG. 3 is a schematic diagram of an example function interface according to some embodiments.

FIG. 4 is a flowchart of an example vehicle location sharing method according to some embodiments.

FIG. 5 is a schematic diagram of an example in-vehicle terminal interface according to some embodiments.

FIG. 6 is a schematic diagram of an example account identity situation of a second account according to some embodiments.

FIG. 7 is a flowchart of an example vehicle location sharing method according to some embodiments.

FIG. 8 is a schematic diagram of an example overall location sharing process according to some embodiments.

FIG. 9 is a schematic diagram of an example in-vehicle terminal interface according to some embodiments.

FIG. 10 is a flowchart of an example vehicle location sharing method according to some embodiments.

FIG. 11 is a schematic diagram of an example overall scheme process according to some embodiments.

FIG. 12 is a schematic diagram of an example in-vehicle terminal interface in an overall scheme process according to some embodiments.

FIG. 13 is a schematic diagram of an example vehicle location sharing implementation environment according to some embodiments.

FIG. 14 is a structural block diagram of an example vehicle location sharing apparatus according to some embodiments.

FIG. 15 is a structural block diagram of an example vehicle location sharing apparatus according to some embodiments

FIG. 16 is a structural block diagram of an example terminal according to some embodiments.

### DESCRIPTION OF EMBODIMENTS

An in-vehicle terminal, which may also be referred to as an in-vehicle information system, generally includes a display system, a communication system, a multimedia system, a global positioning system, and the like. The display system is configured to present running condition information of a vehicle, for example, observing working conditions such as pressure, temperature and light on a dashboard. The communication system is configured to enable communication between the vehicle and other devices. The multimedia system is configured to generate or collect multimedia data, and display the multimedia data through the display system. The global positioning system is configured to obtain geographical location information of the current in-vehicle terminal, namely, the vehicle.

When a user wants to share a vehicle location, a sharing code is typically first generated on an in-vehicle terminal. A sharing party transmits the sharing code to a receiving party through a mobile phone. The receiving party uses a specified application to input the sharing code, so as to obtain geographical location information of the in-vehicle terminal corresponding to the sharing party, thereby realizing the function of real-time location sharing. However, the frequent operation of the mobile phone by the sharing party during a driving process has a great potential driving safety hazard, and easily leads to traffic accidents.

In some examples, a vehicle location sharing method is provided, so as to improve the safety of driving during a vehicle location sharing process.

The vehicle location sharing method in this application is applied to at least one of the following scenes.

First, the method is applied to daily traffic trip scenes.

Schematically, a driver, while driving a vehicle, may not know a destination route or may inform a friend of geographical location information of the current vehicle. Therefore, the location is shared to the friend through a location sharing function provided in an in-vehicle terminal.

Second, the method is applied to emergency alarm notification positioning scenes.

Schematically, many emergency situations are encountered during vehicle travel, such as tire burst, loss of battery power, or help in traffic accidents. The geographical location information of the vehicle may be informed quickly and accurately. With the vehicle location sharing method in this application, geographical location information of a vehicle at a current moment is transmitted to a department terminal providing emergency assistance through an in-vehicle terminal, and real-time geographical location information of the in-vehicle terminal may be obtained after the department terminal providing emergency assistance confirms a location sharing message, so as to improve the timeliness of accident handling.

The foregoing application scenes are merely examples, and others may be possible. The vehicle location sharing method may also be applied to other scenes.

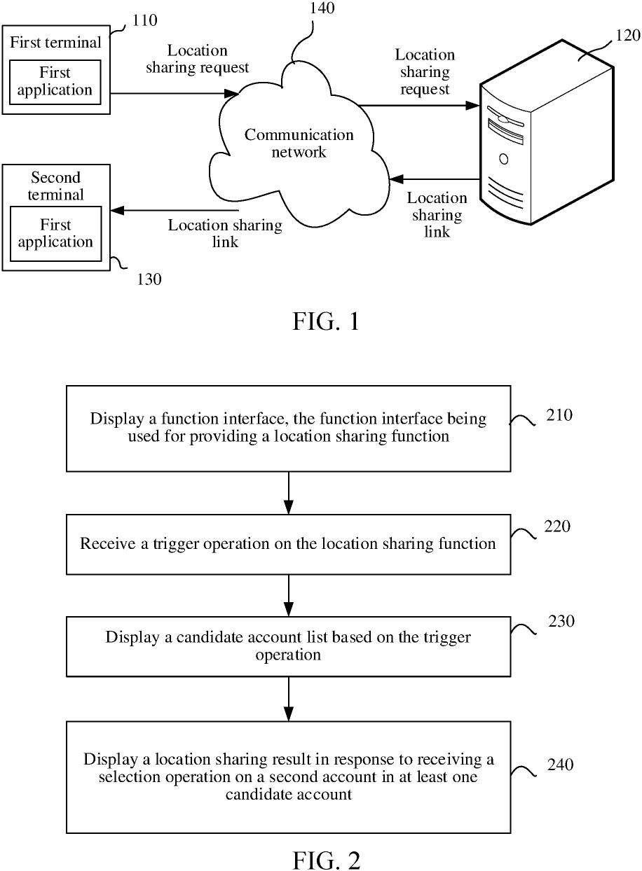

Next, an implementation environment is described. Referring to FIG. 1, a first terminal 110, a server 120 and a second terminal 130 are involved in the implementation environment. The first terminal 110, the second terminal 130 and the server 120 are connected through a communication network 140. The first terminal 110 is implemented as an in-vehicle terminal.

In some embodiments, the first terminal 110 is configured to select a sharing receiving account for location sharing. In some examples, the first terminal 110 may realize a location sharing function. When the location sharing function is triggered, a candidate account list is displayed in the first terminal 110, and a location sharing message is transmitted to the second terminal 130 in which a second account logs through the server 120 according to the selection of the second account. In an example, the foregoing location sharing function is triggered by a location sharing control. The trigger for the location sharing control may be realized through a click/tap operation, may also be realized through voice control, and may also be realized in other trigger manners.

When the first terminal 110 transmits the location sharing message to the second terminal 130 through the server 120, the second terminal 130 displays geographical location information of the first terminal 110 according to a message trigger operation on the location sharing message.

The second terminal 130 may be implemented as a mobile terminal such as a mobile phone, a tablet personal computer, a portable laptop computer, or an in-vehicle terminal, or may be implemented as a desktop computer. The foregoing server may be an independent physical server, a server cluster or a distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms.

A cloud technology refers to a hosting technology, which unifies a series of resources, such as hardware, applications and networks, and realizes the calculation, storage, processing, and sharing of data in a wide area network or a local area network.

In some embodiments, the foregoing server may also be implemented as a node in a blockchain system. A blockchain is a novel application mode of a computer technology, such as distributed data storage, peer to peer transmission, consensus mechanisms, and encryption algorithms.

In conjunction with the introduction of the foregoing terms and the application scenes, the vehicle location sharing method provided in this application is described. The method is performed by an in-vehicle terminal. As shown in FIG. 2, the method includes the following steps:

Step 210: Display a function interface, the function interface being used for providing a location sharing function.

In some examples, the in-vehicle terminal is installed with a first application

The first application includes a social function, and a first account logs in the first application. In some examples, the first application includes at least one of an instant messaging application, a short video social application, a navigation application, a scheduling application, a multimedia playing application, a shopping application, a financial transaction application, and the like

In some examples, a location sharing control is provided in the function interface. The location sharing control is configured to receive a trigger operation on the location sharing function. In some examples, the location sharing control is displayed in at least one of the following manners.

First, the location sharing control is displayed based on an operating system of the in-vehicle terminal.

That is, a function interface is displayed on the operating system of the in-vehicle terminal, such as a homepage interface of the operating system or an intelligent assistant interface of the operating system. The function interface of the operating system includes a function card provided by the installed first application. The function card displays the location sharing control

Second, the in-vehicle terminal is further installed with a second application.

The first application and the second application are two independent applications. That is, a function interface in the second application is displayed, such as a program homepage of the second application or an interface of a specified category in the program. The function interface in the second application includes a function card provided by the first application. The function card includes the location sharing control associated with the location sharing function. In some embodiments, when the second application is run, a user triggers an operation of adding the function card in the function interface so as to display a candidate application capable of adding the function card. The foregoing candidate application includes the first application. When a selection operation on the first application is received, the function card of the first application is displayed in the function interface. Or, the second application automatically reads an installed application in the current in-vehicle terminal when running, and displays function cards provided by the installed application in the function interface, including the function card of the first application. That is, different applications are linked by displaying the function card provided by the first application in the second application, so as to provide candidate accounts under the social function of the first application to the location sharing function of the second application. Different independent applications have independent functions. That is, the different applications have logics independent from each other without complicated coupling. The efficiency of the location sharing function of the second application in determining an object to be shared may be improved.

In some examples, function cards provided by at least one application are displayed in the function interface, including the function card provided by the first application. Or, a function card provided by a specified application is included in the function interface. For example, the function interface is an interface set for the first application for providing functions in the first application.

Third, the function interface is displayed based on the first application installed in the in-vehicle terminal.

That is, the function interface is an interface displayed during the running process of the first application. The function interface includes a location sharing function provided by the first application.

In some examples the in-vehicle terminal is installed with the second application and the function interface is an interface provided by the second application.

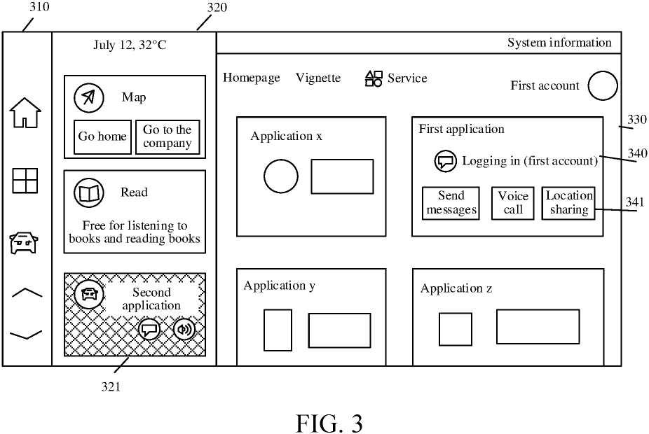

FIG. 3 schematically shows a schematic diagram of a function interface according to some embodiments. As shown in FIG. 3, an interface of an in-vehicle terminal includes an in-vehicle function selection region 310 and an application selection region 320. An application currently selected in the application selection region 320 is a second application 321. Therefore, a function interface 330 of the second application 321 is displayed. The function interface 330 includes function cards provided by a plurality of applications, including a function card 340 provided by a first application. The function card 340 displays a location sharing control 341. In some examples the first application is implemented as an instant messaging application. The first application also has functions of message sending and voice call.

In some examples, the second application also has functions of listening to books, recording, music playing, and the like.

Step 220: Receive a trigger operation on the location sharing function.

In some examples, the trigger operation on the location sharing function may be realized by a first touch operation on the foregoing location sharing control. That is, in response to receiving the first touch operation on the location sharing control, it is determined that the trigger operation on the location sharing function is received. In some examples, the foregoing first touch operation may be realized by at least one of a click/tap gesture, a long-press gesture, a double-click/tap gesture, or a heavy-press gesture. Or, the foregoing trigger operation may be a trigger operation based on a first voice input signal. That is, in response to receiving the first voice input signal, it is determined that the trigger operation on the location sharing function is received. The foregoing first voice input signal is used for performing voice control on the in-vehicle terminal, and the first voice input signal includes a keyword corresponding to the location sharing function. That is, the location sharing function may be called out via touch or voice control. Thus, the location sharing function is quickly invoked through a simple click/tap operation or hands-free voice operations, thereby improving the implementation efficiency of the location sharing function.

In some embodiments, the function card includes at least one control corresponding to a function realizable by the first application. The function control includes a reachable control or a non-reachable control. The reachable control may refer to a control capable of triggering a function corresponding to the reachable control through a touch operation. The non-reachable control may refer to a control used for providing a prompt function or an information display function. The non-reachable control is not correspondingly provided with a reachable operation. That is, the location sharing control may be implemented as the reachable control or the non-reachable control.

Schematically, the implementations of the location sharing control as the reachable control and the non-reachable control are respectively introduced. The trigger operation includes at least one of the following implementations:
1. The location sharing control is implemented as the reachable control.
   1.1. A first touch operation is performed on the location sharing control to trigger the location sharing function.
   1.2. The trigger of the location sharing function is realized via voice input. That is, when a voice input content contains a keyword capable of triggering the location sharing function, the in-vehicle terminal simulates a manual trigger process of the location sharing control according to voices, thereby realizing the trigger of the location sharing function.
   1.3. An image acquisition device is configured on the in-vehicle terminal, a preset specified action is executed within an acquisition range of the image acquisition device. The in-vehicle terminal simulates the manual trigger process of the location sharing control according to the foregoing specified action, thereby realizing the trigger of the location sharing function.
2. The location sharing control is implemented as the non-reachable control. That is, the location sharing control cannot trigger the location sharing function through touching, clicking/tapping, and other operations.
   2.1. The trigger of the location sharing function is realized via voice input.
   2.2. A preset specified action is executed within an acquisition range of the image acquisition device, thereby realizing the trigger of the location sharing function.

The voice input and action operation manners for the non-reachable control are the same as the voice input and action operation manners corresponding to the foregoing trigger control.

The above trigger manner is merely one example, and others may be possible.

Schematically, the trigger of the location sharing control by touch and voice is described as an example.

First, a first touch operation on the location sharing control is received.

The location sharing control corresponds to the location sharing function. When the location sharing control is the reachable control, the first touch operation is performed on the location sharing control, and the location sharing function may be triggered. In some examples, the location sharing control may be a pressable “button type” control. That is, the location sharing control may be a physical control implemented on the in-vehicle terminal. The location sharing control may also be a touchable “touch screen type” control. That is, the location sharing control may be a virtual control implemented on a function interface displayed on a display screen of the in-vehicle terminal.

Second, a first voice input signal is received.

The first voice input signal is used for performing voice control on the in-vehicle terminal. In some examples, a user first wakes up a voice control function of the in-vehicle terminal through a preset wakeup voice, so that the location sharing function is triggered by the first voice input signal after waking up the voice control function.

The first voice input signal is determined as a trigger operation on the location sharing function in response to the first voice input signal including a keyword corresponding to the location sharing function.

The keyword corresponding to the location sharing function may refer to a word which may trigger the location sharing control to realize the trigger of the location sharing function. Schematically, words such as “Enable location sharing”, “Location sharing” and “Sharing location” are inputted in a voice manner. The above words are first voices. The in-vehicle terminal receives first voice input signals of the above words, and triggers the location sharing function in response to keywords “Location” and “Sharing” corresponding to the location sharing function therein.

Step 230: Display a candidate account list based on the trigger operation.

The candidate account list includes at least one candidate account having an association relationship with a first account. The first account is an account logging in the in-vehicle terminal.

In some examples, the first account logs in the first application, and the second application invokes the first account logging in the first application for synchronous login. Schematically, an authorization login interface on which the second application invokes the first application is displayed, and an authorization operation triggered on the authorization login interface is received The authorization operation is used for instructing the second application to invoke the first account logging in the first application for login. That is, different applications independent from each other are quickly connected in the form of account authorization login. Since the second application may quickly connect applications through a pre-stored association identity when performing authorization login through the first account on the first application, the efficiency of the overall process is improved.

In other embodiments, when an account has not yet logged in the first application, account login first displays a candidate account list based on the logged account.

When there is no account logging in the first application, an account login operation may be first performed on the first application in order to realize the location sharing operation. Schematically, the trigger operation for the location sharing control is received, and the first application is invoked. When there is no account logging in the first application, the authorization login interface in the first application is invoked and displayed, so as to log in the first account on the authorization login interface.

In some examples, the first account logs in at least one of the following manners.
1. Independent account login is performed in the first application installed in the in-vehicle terminal. The in-vehicle terminal displays an account login interface of an application based on the trigger operation. The user may select a first account from accounts already stored in the in-vehicle terminal for login, may also realize the login of the first account by inputting an account identity and password of the first account, and may also realize the login of the first account via biological feature recognition (such as face recognition, fingerprint recognition or iris recognition).
2. The login of the first account on the in-vehicle terminal is realized through a mobile terminal establishing a short-range wireless communication connection with the in-vehicle terminal. That is, a first application is installed on the mobile terminal. The first application is an application in a mobile phone version on the mobile terminal. A first account logs in the first application on the mobile terminal. When the in-vehicle terminal establishes a short-range wireless communication connection (such as a Bluetooth connection, a Zigbee communication connection, or a hotspot connection) with the mobile terminal, the first account synchronously logs in the in-vehicle terminal according to the first account logging in the mobile terminal.

In some examples, the first application includes a social function. At least one candidate account provided by the social function in the first application is obtained based on the trigger operation, and a candidate account list is displayed based on the at least one candidate account. That is, the first application having the social function is applied to the in-vehicle terminal, and the candidate account is determined by directly pulling a social contact list through the social function provided by the first application, thereby improving the efficiency of the in-vehicle terminal in providing information interaction between different accounts.

The association relationship may refer to a direct or indirect connection between the first account and the candidate account. The association relationship between the candidate account and the first account includes: 1. a friend relationship between the candidate account and the first account; 2. a same group in which the candidate account and the first account are located; 3. a temporary message conversation that has been initiated by the candidate account to the first account. The above manner of having an association relationship is merely one example, and others may be possible.

In some examples, a window floating layer is superimposed on the function interface based on the trigger operation, and the candidate account list is displayed in the window floating layer based on the at least one candidate account.

A display layer of the window floating layer is located above a display layer of the function interface. Schematically, the window floating layer is a non-full screen window.

In some examples, when the window floating layer is superimposed and displayed on the function interface, the display content on the function interface is weakened, thereby highlighting the display content on the window floating layer. For example, the display brightness of the function interface is reduced, the transparency of the function interface is improved, the display content of the function interface is weakened, and so on.

That is, the account list can be displayed through the window floating layer without modifying the function interface when the candidate account is displayed, thereby ensuring that the original function interface can be directly continuously displayed after the second account is determined, reducing the amount of data modification to the function interface in the development stage, and reducing the complexity of running code corresponding to the function interface.

In some examples, the candidate account list further includes department accounts capable of providing emergency assistance, such as a fire alarm account, a traffic accident alarm account, and a medical assistance alarm account.

The candidate account list is an account list formed by selecting or summarizing the foregoing candidate accounts having an association relationship with the first account. Schematically, all the accounts having an association relationship with the first account are added to the candidate account list as candidate accounts. An account having an association relationship with the first account and having a dialog contact within the latest preset duration may also be added to the candidate account list as a candidate account. An account having an association relationship with the first account and preferentially having an associated friend relationship may also be added to the candidate account list as a candidate account. The candidate accounts in the above candidate account list may be constituted in a preset manner. The display order of the foregoing candidate accounts in the candidate account list may be preset. This is merely one example, and others may be possible

The candidate account list may be a list currently obtained in the first application or may be a list obtained from other applications. Based on different obtaining manners of the candidate account list, the foregoing candidate account list is implemented in at least one of the following manners.

First, the location sharing function is implemented independently in the first application. That is, the at least one candidate account is an account having an association relationship with the first account in the first application. In some examples, the first application has the location sharing function, and the at least one candidate account is an account having a social relationship with the first account in the first application. Then when the location sharing function is triggered in the first application, the at least one candidate account is directly determined from social contacts in the first application, and the candidate account list is displayed.

Second, a second application may be installed in the in-vehicle terminal, and the second application communicates with the account of the first application or the second application invokes the first account logging in the first application for synchronous login. When the location sharing function is triggered by the second application, contact information in the first application is invoked, thereby determining at least one candidate account and displaying the candidate account list.

The above manner of implementing the candidate account list is merely one example, and others may be possible.

Step 240: Display a location sharing result in response to receiving a selection operation on a second account in the at least one candidate account.

The second account is an account logging in a first application installed in a target terminal. The location sharing result includes a result of sharing geographical location information of the in-vehicle terminal from the first account to the second account. Schematically, the in-vehicle terminal indicates the second account for performing location sharing to a server. The server determines a terminal in which the second account logs currently according to the second account, and uses the foregoing terminal as the target terminal.

In some examples, the second account is an account logging in a first application installed in another in-vehicle terminal. The foregoing another in-vehicle terminal is a terminal different from the in-vehicle terminal in which the first account logs. Or, the second account is an account logging in a first application installed in a mobile terminal (such as a mobile phone). When the second account is an account logging in the in-vehicle terminal, the location sharing function is a function realized between the in-vehicle terminals When the second account is an account logging in the mobile terminal, the location sharing function is a function realized between the in-vehicle terminal and the mobile terminal.

In some examples, the in-vehicle terminal receives the selection operation in multiple manners. Schematically, the second account is selected by performing a click/tap operation on the candidate account list. Or, the second account is selected by performing a voice input operation. Or, a default account is preset, and when the second account is selected from the candidate account list, the default account is taken as the second account. Or, the second account is selected by a camera capturing a predetermined gesture. The above manner of receiving, by the in-vehicle terminal, the selection operation is merely one example, and others may be possible.

In some examples, a location sharing message is transmitted to the second account in response to receiving the selection operation on the second account in the at least one candidate account.

The location sharing message includes a location sharing link. The location sharing link is used for providing an entry of a location sharing applet to the second account. The location sharing applet is an applet hosted by the first application. The location sharing result is displayed based on the location sharing link.

In some examples, after the first account transmits the location sharing message to the second account, in an example where a mobile terminal is taken as the target terminal in which the second account logs, the second account receives the location sharing message transmitted by the first account in a dialog box corresponding to the first account, and the location sharing message is displayed as an applet link. In some examples, the dialog box further includes transmitting time when the first account transmits the location sharing message, remark information attached to the first account, system default prompt information, and the like.

In some examples, the first application of the target terminal includes an applet running function, and after receiving the location sharing message and triggers the location sharing link in the location sharing message, the second account jumps to the location sharing applet of the first application so as to receive geographical location information corresponding to the in-vehicle terminal in which the first account logs.

A location sharing function may be provided on an in-vehicle terminal. When the location sharing function is triggered, a candidate account list is displayed, and a second account selected to perform location sharing is determined on the basis of the candidate account list, so as to complete a location sharing process of a first account through a convenient operation, thereby completing location sharing without mobile phone-based cumbersome operations during a driving process, improving the driving safety of the location sharing process, and improving location sharing efficiency by using the in-vehicle terminal. In the meantime, since the location sharing process can be completed without a sharing code through an additional terminal, the data interaction between different terminals is reduced, and the security of information in the location sharing process can be improved. That is to say, the problem of location information leakage caused by the sharing code being maliciously propagated is avoided.

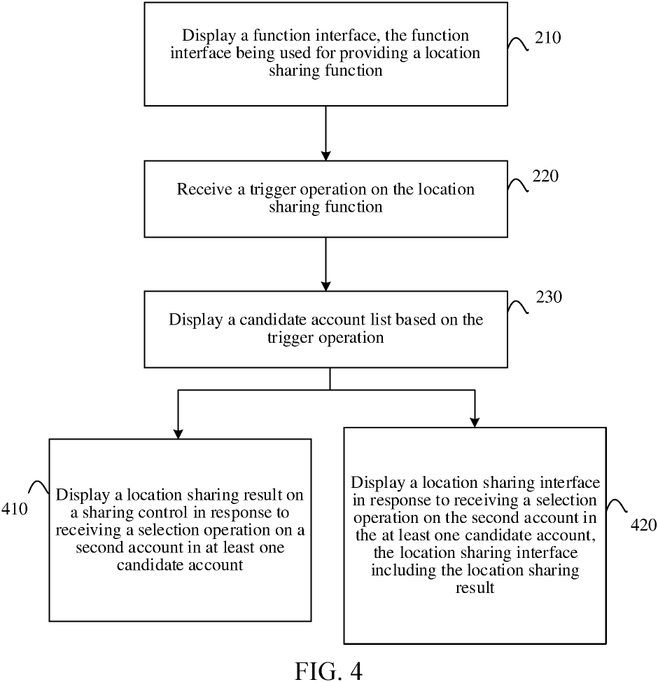

In some examples, a display manner of the foregoing location sharing result includes at least a display manner on the function interface and a display manner in the location sharing interface. Schematically, as shown in FIG. 4, step 240 in the embodiment shown in FIG. 2 may also be implemented as the following step 410 or step 420:

Step 410: Display the location sharing result on the location sharing control in response to receiving the selection operation on the second account in the at least one candidate account through a location sharing control.

After the in-vehicle terminal transmits the location sharing message to the second account through the first account, based on the acceptance of the location sharing message by the second account, the response of the in-vehicle terminal may include at least one of the following cases.

First, the second account does not respond to the location sharing message. That is, the first account does not receive a sharing acceptance signal transmitted by the second account.

In some examples, sharing waiting information is displayed on the location sharing control in response to not receiving the sharing acceptance signal of the second account.

The sharing waiting information is used for indicating waiting for confirmation of a location sharing message by the second account. When the in-vehicle terminal does not receive the sharing acceptance signal of the second account, it is proved that the second account at this moment has not confirmed the location sharing message. The in-vehicle terminal may wait for whether the second account accepts the location sharing message, and displays the sharing waiting information through the location sharing control. Schematically, the sharing waiting information is “Wait for a friend”.

Second, the second account responds to the location sharing message, and transmits a sharing acceptance signal to the first account, so that the in-vehicle terminal responds to the sharing acceptance signal.

In some examples, sharing process information is displayed on the location sharing control in response to receiving the sharing acceptance signal of the second account.

The sharing process information is used for indicating sharing of the geographical location information of the in-vehicle terminal to the second account. Schematically, when the geographical location information between the first account and the second account is being normally shared, the sharing process information displayed in the location sharing control is “Being shared”. When the geographical location information between the first account and the second account is being normally shared and the second account synchronously shares the geographical location information of a terminal thereof with the first account, the sharing process information displayed in the location sharing control is “Being in location sharing”. When the first account or the second account is in a weak signal state (such as in a tunnel or in a mountainous area), the sharing process information displayed in the location sharing control is “Signal being weak”. When the second account terminates receiving the geographical location information, the sharing process information displayed in the location sharing control is “Location sharing has ended”.

In some examples, the sharing process information further includes geographical location information to be currently shared. The geographical location information is simplified in the form of text in the location sharing control. Or, the geographical location information is embodied in the form of a minimap in the location sharing control.

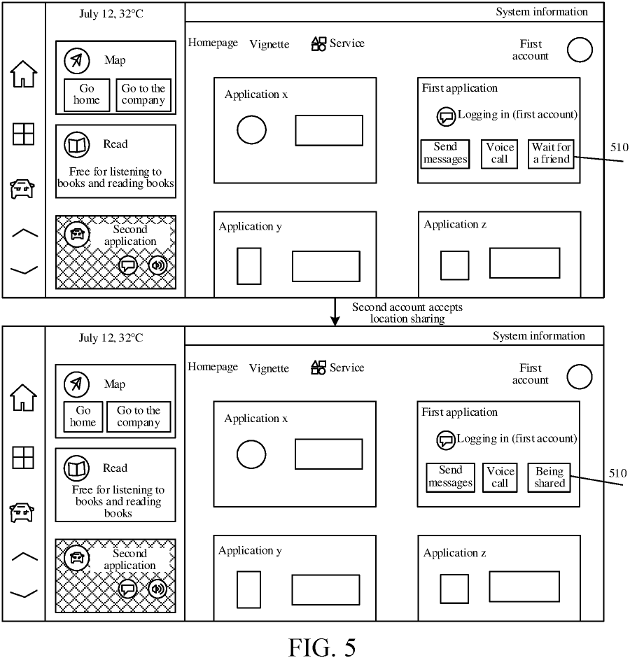

Schematically, as shown in FIG. 5, when the second account does not accept the location sharing, namely, the first account does not receive the sharing acceptance signal transmitted by the second account, “Wait for a friend” is displayed on the location sharing control 510. When the second account accepts the location sharing, “Being shared” is displayed on the location sharing control 510.

In some examples, when the in-vehicle terminal does not receive the sharing acceptance signal transmitted by the second account within a specified duration, sharing end information is displayed. Schematically, “Connection fails, please retry” is displayed on the location sharing control. When the in-vehicle terminal receives a sharing rejection signal transmitted to the second account, sharing rejection information is displayed. Schematically, “The other party has rejected location sharing” is displayed on the location sharing control.

That is, by visually displaying whether the second account responds to the reception of the location sharing, so that the user can intuitively know the state of the current location sharing process, thereby improving the efficiency of information transmission.

Step 420: Display a location sharing interface in response to receiving a selection operation on the second account in the at least one candidate account, the location sharing interface including the location sharing result.

In some examples, the location sharing interface is displayed in a location sharing vignette of the second application.

The second application is an application having a location sharing function. The location sharing vignette is a digital service platform related to location sharing in the second application. The location sharing process may be viewed through the location sharing vignette. In some examples, the foregoing vignette indicates a function module hosted by a specified application in an in-vehicle scene. In some embodiments, the foregoing vignette is realized in the form of streaming data. That is, when the in-vehicle terminal runs the vignette through the specified application, the in-vehicle terminal provides a corresponding function by receiving the streaming data transmitted by the server The in-vehicle terminal directly realizes an application function through the streaming data without downloading and installing the vignette. In some examples, the server corresponding to the foregoing vignette may be a cloud server.

That is, the location sharing vignette is constructed to provide the location sharing function for the in-vehicle terminal, there is no need to install a function implementation application corresponding to the location sharing function in the in-vehicle terminal, and the location sharing function is used through the vignette, thereby reducing the memory occupation of the in-vehicle terminal, so that it is more convenient for the user to use the location sharing function, and the characteristics of small memory occupation, high running speed, and convenient and quick operation are provided. In the meantime, since the location sharing vignette involves function logics related to location sharing, the location sharing vignette does not need to be coupled to other application logics during the development process, and the production cost is low.

In some examples, the location sharing interface is displayed in at least one of the following manners.

First, a location sharing situation is displayed on the location sharing control in response to receiving the selection operation on the second account in the at least one candidate account. The location sharing interface is displayed in response to receiving a second touch operation on the location sharing control.

As a control having the location sharing function, the location sharing control may realize the location sharing function based on the trigger operation, and may change the sharing process information on the location sharing control as the location sharing process changes. Schematically, the location sharing control may more directly reflect the location sharing process. Furthermore, as a reachable control, the location sharing control may trigger the display of the location sharing interface based on the selection operation to observe the location sharing process in more detail.

Second, a location sharing interface is displayed in response to receiving the selection operation on the second account in the at least one candidate account.

That is, upon receiving the selection operation on the second account, a jump is made directly to the location sharing interface for display.

The location sharing interface includes a sharing account presentation region and a map presentation region.

Sharing account presentation region: an account identity of the second account is mainly displayed, the account identity including but not limited to an avatar, a nickname, a personalized signature, and the like. In some examples, at least one second account is selected for sharing of geographical location information, namely, one or more candidate accounts are selected from the candidate account list as second accounts receiving sharing of the geographical location information. In some examples, after one or more candidate accounts are selected from the candidate account list as the second accounts, the selected second accounts are provided in the sharing account presentation region (where the second account which has not accepted a geographical location request is grayed, and the second account which has accepted the geographical location request is displayed normally). In some examples, the location sharing interface further includes a list display control. Based on a trigger operation on the list display control, the location sharing interface may further display a candidate account list, a candidate account displayed in the candidate account list is continuously selected, and the location sharing message is transmitted by taking the selected candidate account as the second account.

In some examples, a removal operation of the second account may also be received in the sharing account presentation region, thereby terminating the sharing of the geographical location information of the in-vehicle terminal to the removed second account.

Map presentation region: the geographical location information of the in-vehicle terminal in which the first account logs is mainly displayed. The geographical location information includes a country, a city, a county, a road, etc. where the vehicle is located, and may further include symbolic coordinates of a region where the vehicle is located, such as a shopping mall, a park or a restaurant. The above is merely one example.

In addition to displaying the geographical location information of the in-vehicle terminal in which the first account logs, the map presentation region may further include weather conditions, traffic conditions, and the like of a geographical location where the in-vehicle terminal is currently located.

In some examples, a waiting identity is displayed in the sharing account presentation region in response to not receiving a sharing acceptance signal of the second account, and the geographical location information of the in-vehicle terminal is displayed in the map presentation region. The waiting identity is used for indicating waiting for confirmation of a location sharing message by the second account.

The waiting identity may be displayed in the sharing account presentation region of the in-vehicle terminal when the in-vehicle terminal does not receive the sharing acceptance signal of the second account. The waiting identity may include at least one of the following: 1. an identifier, displayed in the sharing account presentation region, of waiting for a friend to accept an application; 2. an identifier, displayed in the sharing account presentation region, which indicates that an account identity such as an avatar or a nickname is blank; 3. an identifier, displayed in the sharing account presentation region, which indicates that an account identity such as an avatar or a nickname is to be entered. The above waiting identity in the sharing account presentation region is merely one example, and others may be possible.

The waiting identity is used for indicating waiting for confirmation of the location sharing message by the second account. When the second account confirms the location sharing message, the waiting identity will also correspondingly make a change of the second account confirming the location sharing message, such as displaying a nickname and avatar of the second account of the confirmed location sharing message. When the in-vehicle terminal still does not receive the sharing acceptance signal of the second account after a certain time, the waiting identity may keep in a continuous waiting state, or may remove the second account not accepting the location sharing message because the in-vehicle terminal sets the waiting end condition.

For the map presentation region, when a receiving party does not confirm to receive location information of the in-vehicle terminal in which the first account logs, the map presentation region generally displays environment information of a certain region by centering a geographical location of the in-vehicle terminal, may display environment information of a certain region by centering a geographical location selected in advance, or may display environment information of a certain region by centering a geographical location of the highest building around, and so on. The foregoing map presentation region is merely one example, and others may be possible.

In some examples, an account identity of the second account is displayed in the sharing account presentation region in response to receiving a sharing acceptance signal of the second account, and the geographical location information of the in-vehicle terminal is displayed in the map presentation region. The account identity displayed in the sharing account presentation region includes an identity of an account which is receiving the shared geographical location information of the in-vehicle terminal.

That is, the account receiving the geographical location information of the in-vehicle terminal is displayed on the interface through the account identity, so that the user can quickly know information corresponding to a location receiving party. Thus, it is ensured that the user can quickly determine whether there is a mistaken leakage at the location when performing location sharing, thereby improving the stability of location information sharing.

For the sharing account presentation region, after the in-vehicle terminal receives the sharing acceptance signal of the second account, the sharing account presentation region of the in-vehicle terminal may display an account identity of at least one second account which has confirmed location sharing. Schematically, the account identity is for distinguishing between different accounts for an operator to determine whether the second account confirming the location sharing message is the second account selected by the operator. The account identity includes, but is not limited to, an avatar, a nickname, a personalized signature, and the like of the account.

For the map presentation region, in response to receiving the location sharing message of the second account, the geographical location information of the terminal in which the second account logs is displayed in the map presentation region. In some examples, the map presentation region may also flexibly adjust a geographical range contained as the second account enters. Schematically, the map presentation region may be flexibly adjusted along with the geographical location of the terminal in which the second account logs when the receiving party confirms reception of the geographical location information of the terminal in which the first account logs. For example, after adjustment, both the in-vehicle terminal in which the first account logs and the terminal in which the second account logs are included in the map presentation region. The map presentation region may also be flexibly adjusted as other receiving parties selected by the first account confirm the geographical location information. The map presentation region may also be flexibly reduced or enlarged as the first account is moved closer or further away from the location of the receiving party. The state of the above map presentation region is merely one example, and others may be possible.

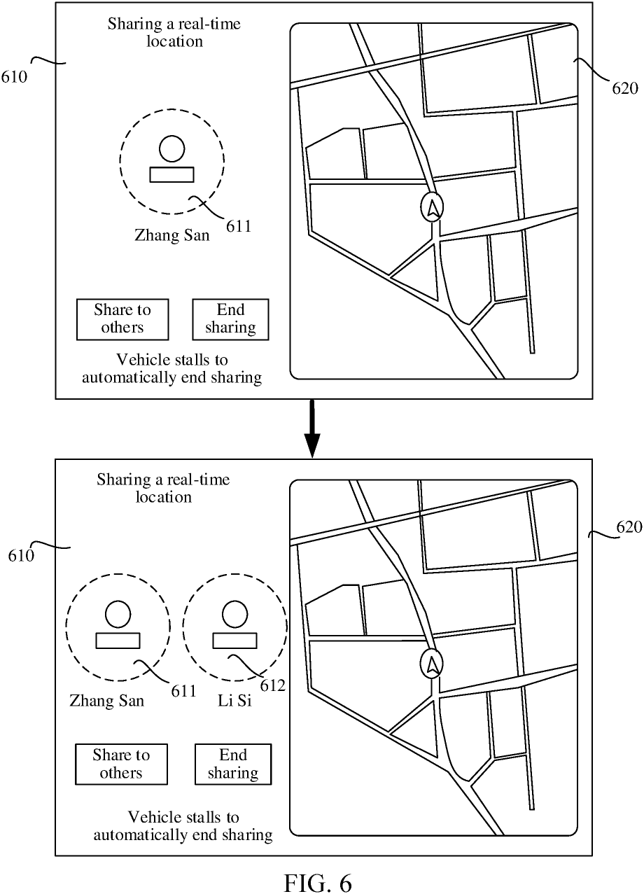

FIG. 6 shows a schematic diagram of an in-vehicle terminal interface according to some embodiments. An account presentation region 610 is displayed on the left side, and a map presentation region 620 is displayed on the right side. First, second accounts invited by a first account include Zhang San and Li Si. When Zhang San receives a geographical location request, an avatar 611 of Zhang San is displayed in the account presentation region 610.

After the second account (such as Zhang San) participates in location sharing, a location sharing message may be continuously transmitted to other candidate accounts, or sharing may be ended. Schematically, Li Si continues to be selected to participate in the sharing of geographical location information. When Li Si receives a geographical location request, an avatar 612 of Li Si is displayed in the account presentation region 610. Furthermore, “Vehicle stalls and location sharing will be automatically ended” is indicated below the account presentation region 610. The map presentation region 620 displays current geographical location information of the in-vehicle terminal.

The map presentation region and the account presentation region shown in FIG. 6 are two parallel regions. In some embodiments, after the terminal displays the map presentation region in full screen, the account presentation region is superimposed and displayed on the map presentation region.

The method may further describe a location sharing result, and provides a location sharing control and a location sharing interface. The location sharing control and the location sharing interface may make a corresponding representation of the location sharing result. The location sharing control may more intuitively indicate whether the second account confirms the state of location sharing, so as to facilitate the operator to know whether the location sharing is successfully received by the receiving party. The location sharing interface may be entered through the location sharing control. The sharing account presentation region and the map presentation region displayed by the location sharing interface may represent, in more detail, account information of the second account and location information of the in-vehicle terminal in which the first account logs, so as to improve the efficiency and accuracy of location sharing.

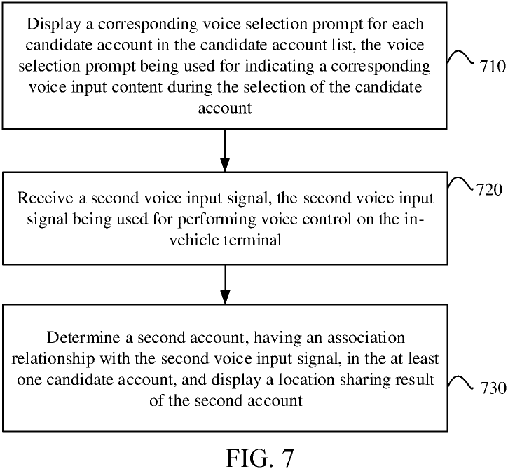

In some examples, the foregoing selection process of the second account is implemented by a voice input operation. Schematically, as shown in FIG. 7, step 240 in the embodiment shown in FIG. 2 may also be implemented as the following step 710 to step 730:

Step 710: Display a corresponding voice selection prompt for each candidate account in the candidate account list, the voice selection prompt being used for indicating a corresponding voice input content during the selection of the candidate account.

The candidate account list includes at least one candidate account, and different candidate accounts are distinguished from each other due to different identities such as nicknames and avatars. Considering that the receiving party may not be accurately selected because it is difficult to distinguish and express nicknames and avatars when selecting the candidate account from the candidate account list, an appropriate voice selection prompt may be made for each candidate account in the candidate account list. Schematically, the voice selection prompts are set to “first”, “second”, and “third” in the order of the candidate account list. And when selecting the receiving party, the voice selection prompt corresponding to the selected candidate account may be inputted by voices according to the voice selection prompt corresponding to each candidate account, and the candidate account is taken as the second account.

In some embodiments, the voice selection prompt is displayed in at least one of the following manners.

First, a prompt content is displayed at a preset location of a candidate item of a candidate account in the candidate account list. For example, the prompt content is displayed on the right side of the avatar of the candidate account. The prompt content corresponding to account 1 is “first”, and the prompt content corresponding to account 2 is “second”.

Second, the avatar of the candidate account is displayed as the prompt content instead in the candidate account list, and a name of the candidate account is displayed at a preset location around the avatar (such as a remark name or an account user name). For example, the avatar of the first candidate account displays the prompt content “1”, and the remark name correspondingly displayed on the right side is “friend A”. The avatar of the second candidate account displays the prompt content “2”, and the remark name correspondingly displayed on the right side is “friend B”.

Third, candidate items corresponding to each candidate account are represented in different expressions in the candidate account list. Schematically, the candidate items corresponding to each candidate account are represented in different background colors. For example, the background color corresponding to account 1 is red, indicating that the user selects account 1 through voice input “red”, and the background color corresponding to account 2 is green, indicating that the user selects account 2 through voice input “green”.

The foregoing display manner is merely one example, and others may be possible.

In some examples, the voice selection prompt may be implemented as at least one of a text prompt, a color prompt, a symbol/shape prompt, a numeric prompt, an alphabetic prompt, and the like.

Step 720: Receive a second voice input signal, the second voice input signal being used for performing voice control on the in-vehicle terminal.

In some examples, in response to the second voice input signal including voice input content associated with n candidate accounts, n candidate accounts are taken as second accounts having an association relationship with the second voice input signal, and n is a positive integer.

Step 730: Determine a second account, having an association relationship with the second voice input signal, in the at least one candidate account, and display a location sharing result of the second account.

Schematically, five accounts are currently displayed in the candidate account list, and account A in the five candidate accounts corresponds to the voice selection prompt “first”. Account B corresponds to the voice selection prompt “second”. Account C corresponds to the voice selection prompt “third”. Account D corresponds to the voice selection prompt “fourth”. Account E corresponds to the voice selection prompt “fifth”. After receiving the second voice input signal transmitted by the user, the in-vehicle terminal converts the second voice input signal into a text format, and a text content is “first, third and fourth”, so as to determine that candidate accounts to be selected currently by the user are account A, account C and account D.

That is, when a target account for location sharing is determined from the candidate accounts, it is achieved through voice control, and no manual user operation is required, thereby ensuring the safety of location sharing during the driving process. When the second account is determined through voice control, a relationship between the candidate account and the specified voice selection prompt is established, thereby improving the accuracy of voice recognition. The situation of mistaken recognition in the voice recognition process can be reduced, thereby improving the efficiency of the overall process and reducing the re-operations of account selection after mistaken voice recognition.

In some examples, the processing of the location sharing message is described from the perspective of the second account. After receiving the location sharing message of the first account, the second account may confirm the location sharing transmitted by the in-vehicle terminal so as to view location information of the first account.

In some examples, the second account authorizes an account identity to obtain location information of the first account. Schematically, after receiving the location sharing message of the first account, the second account selects an authorized avatar and nickname. At this moment, the second account may learn location information of the in-vehicle terminal in which the first account logs, so as to realize location sharing. In some examples, a prompt box for prompting to view friend distance information on a terminal in which the second account logs, and the second account may authorize personal location information by clicking/tapping the prompt box. At this moment, the map presentation region of the in-vehicle terminal will display geographical location information of the terminal in which the second account logs, so as to achieve the effect of location sharing.

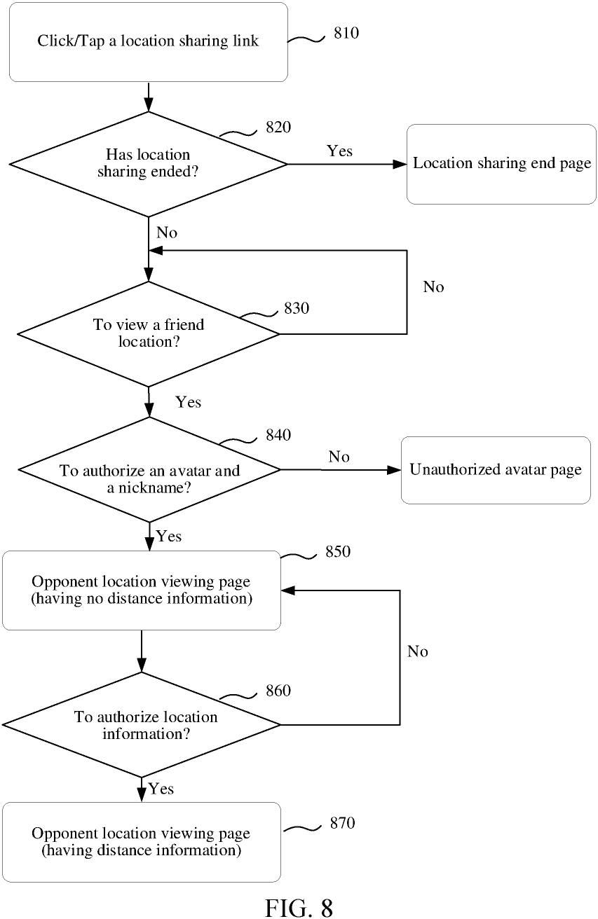

Schematically, the geographical location information of the terminal in which the first account logs can be obtained by the second account with an authorized account identity. FIG. 8 shows a flowchart of authorization of different account identities for location sharing in a first application of a terminal in which a second account logs and a location sharing process.

Step 810: Click/Tap a location sharing link.

The location sharing link is clicked or tapped on a terminal in which a second account logs to enter a location sharing applet in a first application. The first application is the same as the first application installed in the in-vehicle terminal.

Step 820: Determine whether location sharing ends.

In some examples, the first application will first determine whether the location sharing ends. If the location sharing process corresponding to a location sharing message to be transmitted has ended, a location sharing end page will be displayed after opening the location sharing link. If the location sharing process has not ended, it is prompted that a friend is sharing a real-time location of a vehicle after a receiving party opens the location sharing link.

Step 830: Inquire whether to view a friend location.

After the receiving party enters a location sharing interface, the first application of the terminal in which the second account logs will inquire whether the receiving party views the friend location. If the receiving party does not view the friend location, the operation is stopped on a page “whether to view the friend location”. If the receiving party clicks/taps to view the friend location, the first application will perform the next operation.

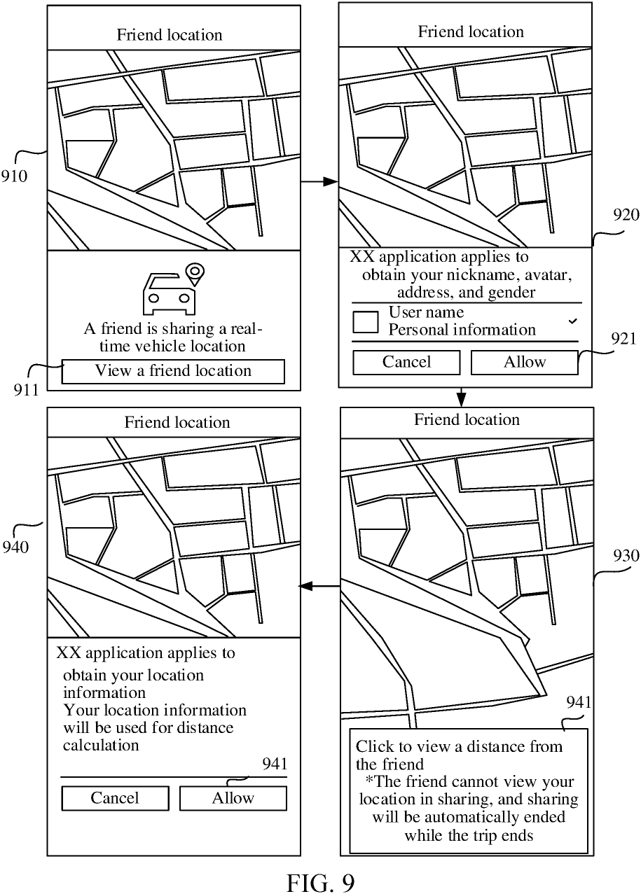

Schematically, as shown in FIG. 9, a prompt message is displayed in an interface 910. The prompt message is “Friend is sharing a real-time vehicle location”. A user selects a control 911 so as to indicate that the real-time vehicle location of the friend is to be viewed.

Step 840: Inquire whether to authorize an avatar and a nickname.

If the friend location is clicked or tapped to view, the first application will inquire whether the receiving party authorizes the avatar, the nickname, and the like. If the receiving party does not authorize the avatar, the nickname, and the like, an unauthorized avatar page is entered. If the receiving party determines to authorize the avatar, the nickname, and the like, it is considered that the location sharing message is confirmed.

Schematically, as shown in FIG. 9, an authorization message is displayed in an interface 920 for indicating that personal information of the second account is obtained, such as the avatar or the nickname. The user selects a control 921, so as to indicate that authorization to obtain personal information is provided.

Step 850: Enter an opponent location viewing page (having no distance information).

The receiving party may enter the opponent location viewing page after the receiving party authorizes the account information such as the avatar or the nickname, thereby realizing location sharing. At this moment, the opponent location viewing page does not include distance information between the in-vehicle terminal and the mobile terminal.

Schematically, as shown in FIG. 9, location information of the first account is displayed in an interface 930

Step 860: Inquire whether to authorize location information. After entering the opponent location viewing page, the page may inquire whether the receiving party authorizes personal location information. If the receiving party does not authorize the location information, it is represented that the location information of the mobile terminal may not be viewed. If the receiving party authorizes the location information, it is represented that the location information of the terminal corresponding to the receiving party can be viewed.

Schematically, as shown in FIG. 9, a location information obtaining request is displayed in an interface 940 for requesting to obtain current geographical location information of a target terminal. The user indicates approval of authorization of the geographical location information through a trigger operation on a control 941.

Step 870: Enter an opponent location viewing page (having distance information).

If the location information is to be authorized, it is possible to view the location information of the in-vehicle terminal and also the distance information between the target terminal and the in-vehicle terminal.

A safer operation manner in a candidate account selection process, namely a voice operation, is schematically illustrated. Considering that a candidate account may not be correctly selected as a second account because of the calling of the candidate account or other reasons during voice triggering, a corresponding voice prompt is displayed for each candidate account in the candidate account list. By oly performing voice triggering according to the voice prompt corresponding to each candidate account in the candidate account list, the location sharing function may be triggered without clicking/tapping a function control, thereby improving the safety factor of driving to a greater extent.

In some examples, the second account may know the geographical location information of the in-vehicle terminal in which the first account logs by confirming the location sharing message, and share the geographical location information thereof to the first account so as to simultaneously present the geographical location information of the in-vehicle terminal in which the first account logs and the terminal in which the second account logs on the map presentation interface, thereby achieving location sharing between the in-vehicle terminal and the target terminal, making the location sharing function more flexible, and effectively expanding the application range of the location sharing function.

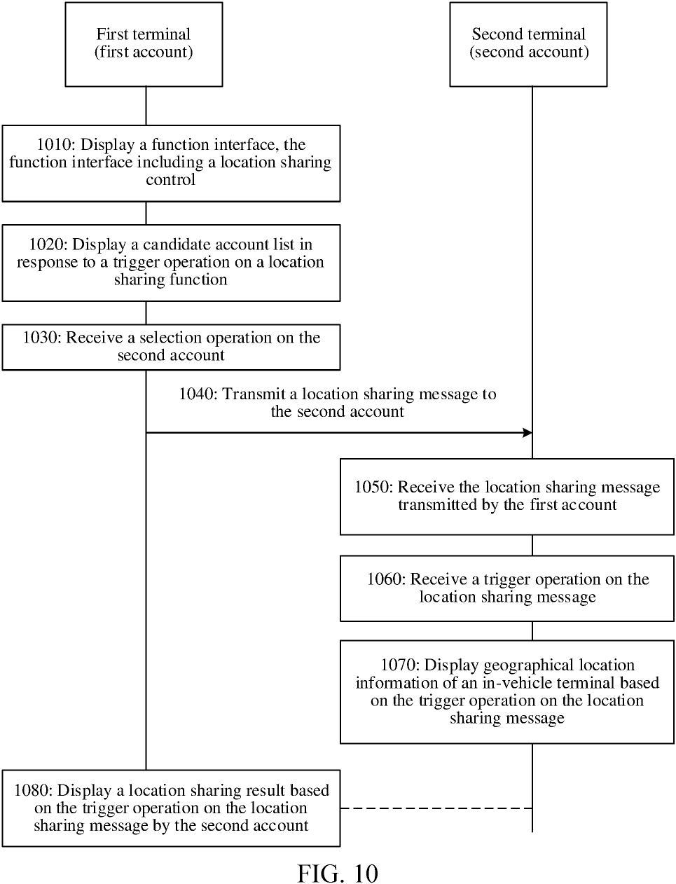

In some examples, a vehicle location sharing system includes a first terminal and a second terminal. The vehicle location sharing method is described with an interaction process between the two terminals. The foregoing first terminal is an in-vehicle terminal. A first account logs in the first terminal. A second account logs in the second terminal. There is an association relationship between the first account and the second account. FIG. 10 shows a flowchart of a vehicle location sharing method according to another embodiment of this application. As shown in FIG. 10, the method includes the following steps:

Step 1010: Display, by a first terminal, a function interface, the function interface including a location sharing control.

The location sharing control corresponds to a location sharing function.

In some examples, the first terminal is installed with a first application, and a first account logs in the first application in the first terminal. A second terminal is installed with a first application, and a second account logs in the first application in the second terminal.

In some examples, the first terminal is further installed with a second application.

The first terminal is further configured to display the function interface in the second application. The function interface includes a function card provided by the first application. The function card includes a location sharing control. The location sharing control is configured to receive a trigger operation on the location sharing function.

Step 1020: Display, by the first terminal, a candidate account list in response to a trigger operation on a location sharing function.

In some examples, the first terminal is further configured to: obtain at least one candidate account having an association relationship with the first account in the first application in response to the trigger operation on the location sharing function; and display the candidate account list based on the at least one candidate account.

Step 1030: Receive, by the first terminal, a selection operation on a second account.

In some examples, the first terminal receives the selection operation in multiple manners. Schematically, the second account is selected by performing a click/tap operation on the candidate account list. Or, the second account is selected by performing a voice input operation. Or, a default account is preset, and when the second account is selected from the candidate account list, the default account is taken as the second account. Or, the second account is selected by a camera capturing a predetermined gesture. The above manner of receiving, by the in-vehicle terminal, the selection operation is merely one example, and others are possible.

Step 1040: Transmit, by a first account of the first terminal, a location sharing message to the second account.

The location sharing message includes a location sharing link. The location sharing link is used for providing an entry of a location sharing applet to the second account. The location sharing applet is an applet hosted by the first application. That is, in response to receiving the selection operation on the second account in the at least one candidate account, the location sharing message is transmitted to the second account in the second terminal.

By realizing the establishment of location sharing in the second terminal via an applet, the memory occupation of the second terminal can be reduced and the convenience of operation can be improved.

Step 1050: Receive, by a second terminal, the location sharing message transmitted by the first account.

In some examples, after the first account transmits the location sharing message to the second account, in an example where a mobile terminal is taken as the second terminal in which the second account logs, the second account receives the location sharing message transmitted by the first account in a dialog box corresponding to the first account, and the location sharing message is displayed as an applet link.

Step 1060: Receive, by the second terminal, a trigger operation on the location sharing message.

In some examples, the second terminal receives a click/tap operation on the location sharing message.

Step 1070: Display, by the second terminal, geographical location information of an in-vehicle terminal based on the trigger operation on the location sharing message.

In some examples, a jump is made to a location sharing applet based on the trigger operation on the location sharing message. The geographical location information of the first terminal is displayed in the location sharing applet

Step 1080: Display, by the first terminal, a location sharing result based on the trigger operation on the location sharing message by the second account.

In some examples, the first terminal displays a location sharing result in a location sharing vignette of the second application based on the trigger operation on the location sharing message by the second account.

In some examples, location sharing between the first account and the second account is ended in response to a location sharing process meeting a termination condition.

The termination condition may refer to a condition for ending the location sharing process.

In some examples, the location sharing between the first account and the second account is ended in response to the first account logging out in the first application

When the first account logging in the first terminal realizes the log-out operation, the second account may not obtain the geographical location information of the terminal in which the first account logs, and the location sharing between the first account and the second account is ended.

In some examples, the location sharing between the first account and the second account is ended in response to stalling and power failure of a vehicle corresponding to the first terminal.

When stalling and power failure of the vehicle corresponding to the first terminal, the first terminal may not run the function interface and thus may not maintain the continuous working state of the function control, and the second account may not obtain the geographical location information of the terminal in which the first account logs. Therefore, the location sharing between the first account and the second account is ended.

In some examples, the location sharing between the first account and the second account is ended in response to receiving a location sharing termination operation.

The first terminal in which the first account logs may end the location sharing operation, and the receiving party of the terminal in which the second account logs may also end the confirmation of the location sharing or exit the location sharing. At this moment, the first terminal may receive the operation of terminating the location sharing and end the location sharing between the first account and the second account.

In some examples, the location sharing between the first account and the second account is ended in response to a location obtaining failure state of the in-vehicle terminal lasting for a duration threshold.

When a location sharing confirmation message of the second account is not received, the first terminal displays a state waiting for the receiving party to confirm location sharing. In order to avoid being in a waiting state for a long time, a certain duration may be set as a duration threshold for ending location sharing. When the first terminal transmits the location sharing message to the second account, if the second account does not confirm receiving location sharing within a specified duration threshold for confirming a location sharing state, the first terminal will end location sharing between the first account and the second account when reaching the threshold.

Considering that problems such as high power consumption of the vehicle and privacy leakage of the vehicle location may be caused during the location sharing process since the second account does not necessarily confirm the location sharing message transmitted by the in-vehicle terminal in time in the location sharing process, a location sharing end condition is set. By setting the end condition, the in-vehicle terminal may avoid being in a location sharing state after initiating location sharing, thereby saving the power of the vehicle on which the in-vehicle terminal is located, and better protecting the privacy of the vehicle location information.

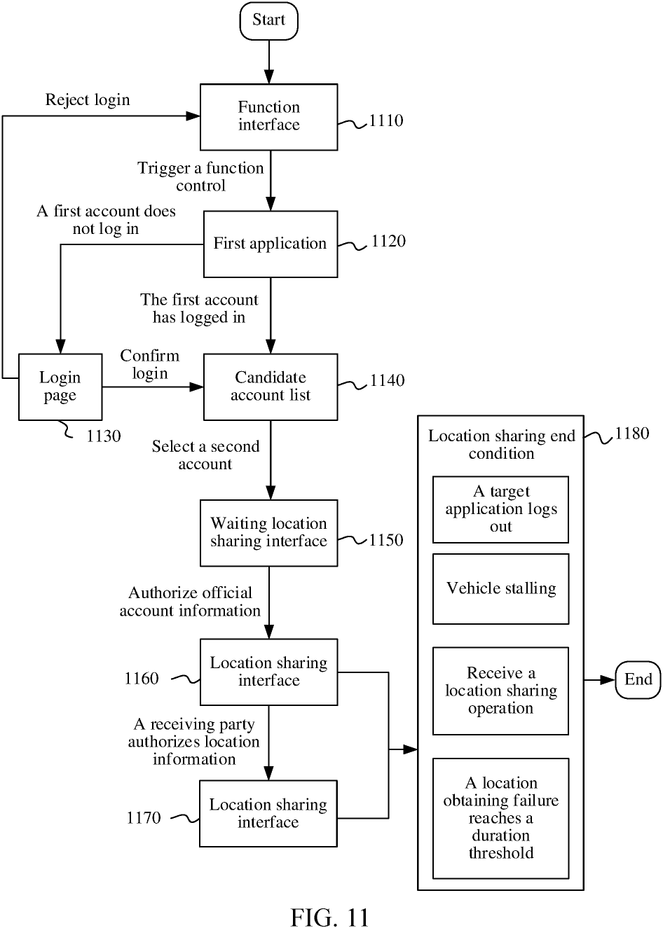

For ease of understanding, FIG. 11 shows a schematic overall scheme flowchart of this method. The contents in the flow block are schematic presentation contents of an in-vehicle terminal.

First, a location sharing control on a function interface 1110 is triggered. A second application corresponding to the location sharing control responds to the trigger. If a first account of a first application 1120 has not logged in, a login interface 1130 of the first account is displayed on the in-vehicle terminal, and an operator determines whether the first account logs in. If the operator rejects login of the first account, a jump is made to the function interface 1110. If the operator confirms that the first account logs in or the first account of the first application has already logged in, a candidate account list 1140 is displayed on the in-vehicle terminal. Thereafter, the operator selects one or more candidate accounts from the candidate account list 1140 as a second account, the in-vehicle terminal transmits a location sharing message to the second account, and the in-vehicle terminal displays a waiting location sharing interface 1150. If a receiving party authorizes relevant account information, the in-vehicle terminal displays a location sharing interface 1160 in response to a location receiving signal. Then, if the receiving party authorizes location information of a terminal in which the second account logs, the in-vehicle terminal enters a location sharing interface 1170. At this moment, the operator may know geographical location information of the terminal in which the second account logs. Finally, when the in-vehicle terminal receives a condition for ending location sharing, the location sharing is ended after the in-vehicle terminal displays a location sharing ending condition 1180.

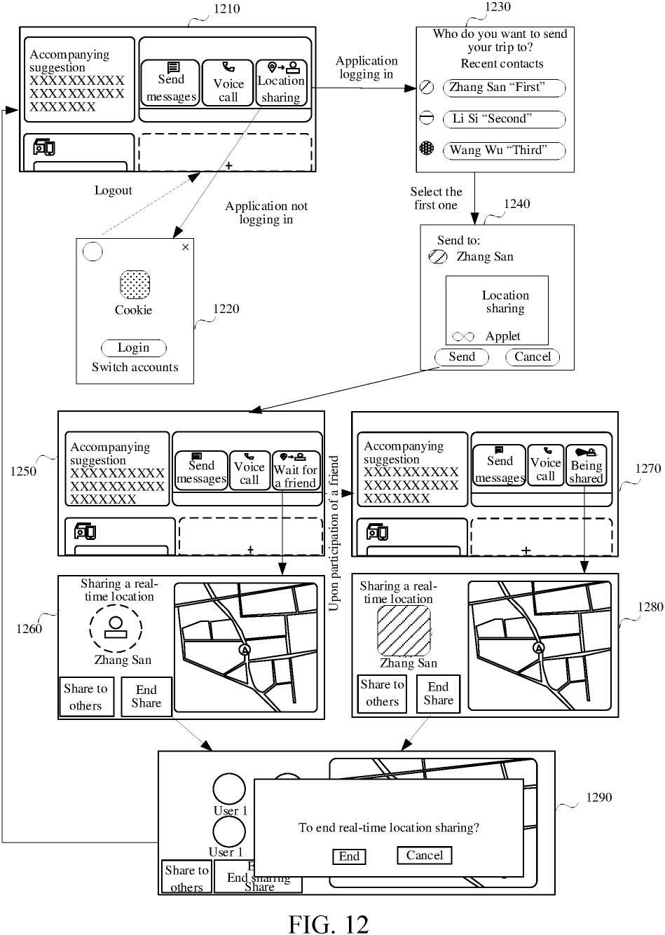

FIG. 12 shows a schematic overall scheme interface diagram of this method. FIG. 12 is a perspective view of an in-vehicle terminal.

First, a trigger operation is performed on a location sharing control in a card corresponding to a first application on a function interface 1210 of a second application, thereby invoking a contact in the first application. When an account does not log in the first application, a login interface 1220 is displayed, and the first application is logged in through the login interface 1220. When a first account logs in the first application, a candidate account list 1230 is displayed, including a plurality of candidate accounts having an association relationship with the first account.

A location sharing transmitting page 1240 for transmitting a location sharing message to a second account (Zhang San) is displayed by selecting the second account in the candidate account list 1230.

After transmitting the location sharing message to the second account, an updated function interface 1250 is displayed. Information waiting for the second account to join is displayed on a location sharing control, namely, “Wait for a friend”. When a trigger operation on the location sharing control is received, a location sharing interface 1260 is displayed, and a state of waiting for a friend to accept the invitation is displayed in the location sharing interface 1260.

When the second account is added to location sharing, an updated function interface 1270 is displayed. A sharing status is displayed on the location sharing control, namely, “Being shared”. When the trigger operation on the location sharing control is received, a location sharing interface 1280 is displayed, and a state of sharing geographical location information to the second account (Zhang San) is displayed in the location sharing interface 1280.

When a sharing end operation is received, a sharing end prompt 1290 is displayed for prompting a user to confirm whether to end real-time location sharing.

An in-vehicle terminal does not need to operate a mobile phone, a function control capable of triggering a location sharing function in a second application is triggered through a function interface of the in-vehicle terminal, and a first application is invoked. A corresponding candidate account list is introduced according to a first account logging in the first application, at least one second account is selected from the candidate account list, and the in-vehicle terminal may directly transmit a location sharing link to a receiving party according to the selected second account. The in-vehicle terminal may make a more detailed representation of a series of processes, and may end location sharing in response to a location sharing end condition. The convenience of sharing a vehicle location with others during the vehicle driving process can be effectively improved, the safety of driving can be improved, and privacy leakage caused by forgetting to stop location sharing can also be avoided.

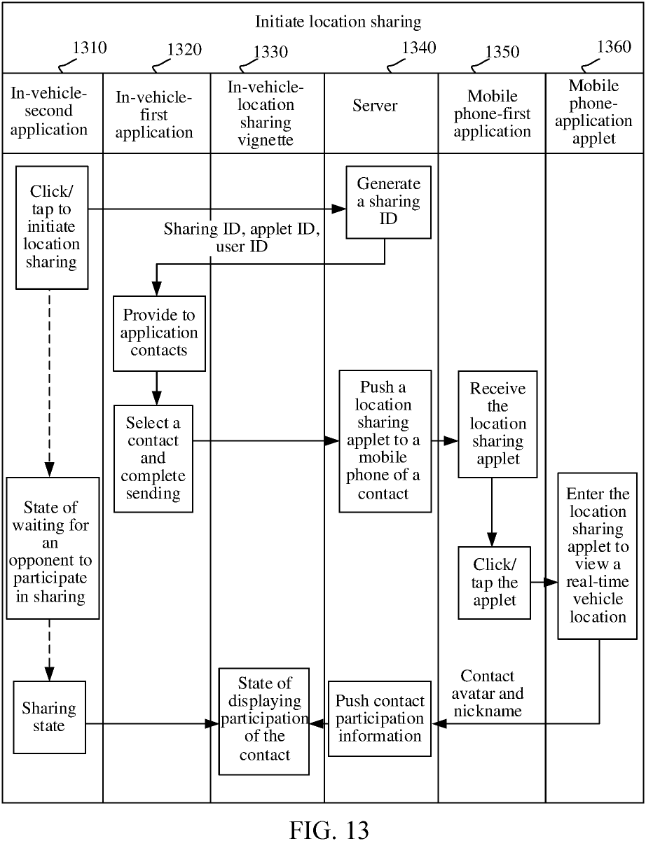

FIG. 13 is a schematic diagram of a vehicle location sharing implementation environment according to some embodiments. Vehicle location sharing relates to the field of human-computer interaction, and an implementation environment describes an interaction process between an in-vehicle terminal and a schematic mobile terminal (mobile phone).

The in-vehicle terminal is installed with a first application and a second application, and the mobile phone is installed with a first application. The first applications provide an applet function.

The in-vehicle terminal receives a trigger operation on a location sharing function through a second application 1310. A mini-card corresponding to a first application 1320 is displayed in a function interface of the second application 1310. A location sharing control is displayed in the mini-card. A click/tap operation on the location sharing control serves as a trigger operation on a location sharing function.

The in-vehicle terminal transmits a location sharing request to a server 1340 through the second application 1310. After generating a sharing identity (ID) according to the location sharing request, the server 1340 transmits the sharing ID, an applet ID (corresponding to the location sharing function) and a user ID (corresponding to a first account) to the first application 1320 of the in-vehicle terminal. The first application 1320 receives information transmitted by the server 1340, invokes contact data (namely, a candidate account having an association relationship with the first account), and displays a contact list on the in-vehicle terminal.

The user selects a contact in the contact list and transmits a location sharing message to the server 1340. The server 1340 transmits a location sharing applet to a first application 1350 of the mobile phone end according to the location sharing message. After receiving the location sharing applet, the first application 1350 of the mobile phone clicks/taps the location sharing applet, runs the location sharing applet in an application applet 1360, and views a real-time location of a vehicle.

In some examples, the application applet 1360 authorizes the server 1340 to obtain an avatar and a nickname of the contact The server 1340 transmits account information of the contact participating in location sharing to a location sharing vignette 1330 of the in-vehicle terminal, including the avatar and the nickname. The location sharing vignette 1330 of the in-vehicle terminal displays a current state of the contact participating in location sharing. The second application 1310 of the in-vehicle terminal is in a state of waiting for the contact to participate in the location sharing in response to triggering a location sharing function. When the contact participates in the location sharing, the in-vehicle terminal 1310 displays the state of sharing in response to the state of the contact participating in the location sharing. In the meantime, the server 1340 is assisted to display the state of the contact having participated in the location sharing in the location sharing vignette 1330 of the in-vehicle terminal.

Through the above operations, the location sharing process may be completed more conveniently, thereby avoiding completion of location sharing via mobile phone-based cumbersome operations during the driving process, and improving the driving safety of the location sharing process.

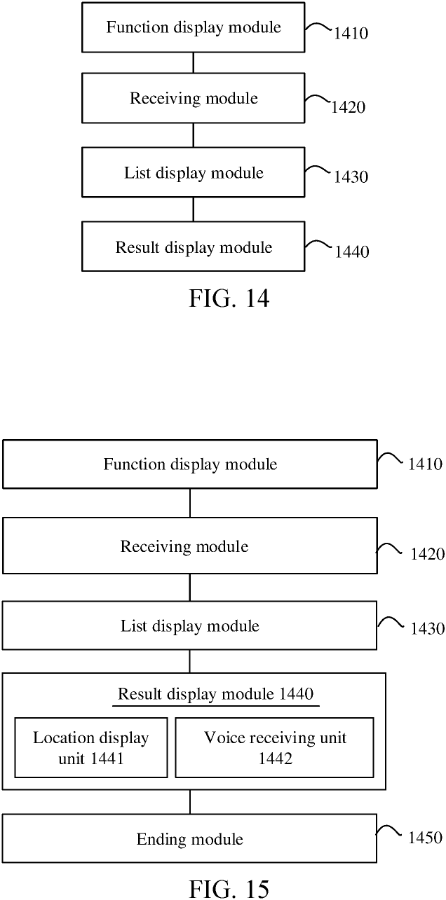

FIG. 14 is a structural block diagram of a vehicle location sharing apparatus according to some embodiments. As shown in FIG. 14, the apparatus includes the following components:
a function display module 1410, configured to displaying a function interface, the function interface being used for providing a location sharing function;
a receiving module 1420, configured to receive a trigger operation on the location sharing function;
a list display module 1430, configured to display a candidate account list based on the trigger operation, the candidate account list including at least one candidate account having an association relationship with a first account, and the first account being an account logging in the in-vehicle terminal; and
a result display module 1440, configured to display a location sharing result in response to receiving a selection operation on a second account in the at least one candidate account, the location sharing result including a result of sharing geographical location information of the in-vehicle terminal from the first account to the second account.

The term module (and other similar terms such as unit, submodule, etc.) may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform functions and achieve goals such as those described in this disclosure, and may work together with other related modules, programs, and components to achieve those functions and goals.

As shown in FIG. 15, in some examples, the in-vehicle terminal is installed with a first application, the first application includes a social function, and the first account logs in the first application.

The list display module 1430 is further configured to: obtain the at least one candidate account provided by the social function in the first application based on the trigger operation; and display the candidate account list based on the at least one candidate account.

In some examples, the list display module 1430 is further configured to: superimpose and display a window floating layer on the function interface; and display the candidate account list in the window floating layer based on the at least one candidate account.

In some examples, the in-vehicle terminal is further installed with a second application.

The function display module 1410 is further configured to display the function interface in the second application. The function interface includes a function card provided by the first application. The function card includes a location sharing control.

In some examples, the function display module 1410 is further configured to: display an authorization login interface on which the second application invokes the first application; and receive an authorization operation on the authorization login interface, the authorization operation being used for instructing the second application to invoke the first account logging in the first application for login.

In some examples, the receiving module 1420 is further configured to: receive a first touch operation on the location sharing control, the location sharing control being displayed on the function interface; or, receive a first voice input signal, the first voice input signal being used for performing voice control on the in-vehicle terminal; and determine the first voice input signal as a trigger operation on the location sharing function in response to the first voice input signal including a keyword corresponding to the location sharing function.

In some examples, the result display module 1440 is further configured to: display the location sharing result on the location sharing control in response to receiving a selection operation on the second account in the at least one candidate account through a location sharing control; or, display a location sharing interface in response to receiving a selection operation on the second account in the at least one candidate account, the location sharing interface including the location sharing result.

In some examples, the result display module 1440 further includes:

a location display unit 1441, configured to: display a location sharing situation on the location sharing control in response to receiving a selection operation on the second account in the at least one candidate account; and display the location sharing interface in response to receiving a second touch operation on the location sharing control.

In some examples, the location display unit 1441 is further configured to display the location sharing interface in a location sharing vignette of the second application. The location sharing vignette is a service platform in the second application for providing the location sharing function.

In some examples, the location display unit 1441 is further configured to: display sharing waiting information on the location sharing control in response to not receiving a sharing acceptance signal of the second account, the sharing waiting information being used for indicating waiting for confirmation of a location sharing message by the second account; or display sharing process information on the location sharing control in response to receiving a sharing acceptance signal of the second account, the sharing process information being used for indicating sharing of the geographical location information of the in-vehicle terminal to the second account.

In some examples, the location sharing interface includes a sharing account presentation region and a map presentation region.

The result display module 1440 is further configured to: display a waiting identity in the sharing account presentation region in response to not receiving a sharing acceptance signal of the second account, and display the geographical location information of the in-vehicle terminal in the map presentation region, the waiting identity being used for indicating waiting for confirmation of a location sharing message by the second account; or display an account identity of the second account in the sharing account presentation region in response to receiving a sharing acceptance signal of the second account, and display the geographical location information of the in-vehicle terminal in the map presentation region, the account identity displayed in the sharing account presentation region including an identity of an account which is receiving the shared geographical location information of the in-vehicle terminal.

In some examples, the result display module 1440 further includes:

a voice receiving unit 1442, configured to: receive a second voice input signal, the second voice input signal being used for performing voice control on the in-vehicle terminal; and determine a second account, having an association relationship with the second voice input signal, in the at least one candidate account, and display a location sharing result of the second account.

In some examples, the voice receiving unit 1442 is further configured to display a corresponding voice selection prompt for each candidate account in the candidate account list. The voice selection prompt is used for indicating a corresponding voice input content during the selection of the candidate account.

In some examples, the result display module 1440 is further configured to transmit a location sharing message to the second account in response to receiving a selection operation on the second account in the at least one candidate account. The location sharing message includes a location sharing link. The location sharing link is used for providing an entry of a location sharing applet to the second account. The location sharing applet is an applet hosted by the first application.

In some examples, the apparatus further includes:

an ending module 1450, configured to end location sharing between the first account and the second account in response to a location sharing process meeting a termination condition.

In some examples, the ending module 1450 is further configured to: end location sharing between the first account and the second account in response to the first account logging out in the first application; or end location sharing between the first account and the second account in response to stalling and power failure of a vehicle corresponding to the in-vehicle terminal; or end location sharing between the first account and the second account in response to receiving a location sharing termination operation; or end location sharing between the first account and the second account in response to a location obtaining failure state of the in-vehicle terminal lasting for a duration threshold.

A location sharing function may be provided on an in-vehicle terminal. When the location sharing function is triggered, a candidate account list is displayed, and a second account selected to perform location sharing is determined on the basis of the candidate account list, so as to complete a location sharing process of a first account through a convenient operation, thereby completing location sharing without mobile phone-based cumbersome operations during a driving process, improving the driving safety of the location sharing process, and improving location sharing efficiency by using the in-vehicle terminal. In the meantime, since the location sharing process can be completed without a sharing code through an additional terminal, the data interaction between different terminals is reduced, and the security of information in the location sharing process can be improved. That is to say, the problem of location information leakage caused by the sharing code being maliciously propagated is avoided.

The vehicle location sharing apparatus provided in the foregoing embodiments is illustrated with an example of division of the foregoing function modules. In some examples, the foregoing functions may be allocated to and completed by different function modules. That is, the internal structure of the device is divided into different function modules, so as to complete all or part of the functions described above.

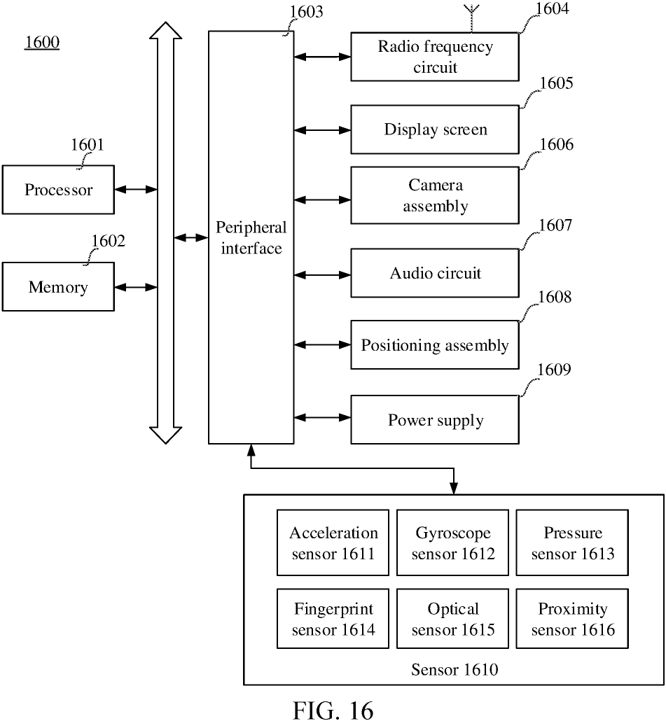

FIG. 16 shows a structural block diagram of an electronic device 1600 according to some embodiments.

Generally, the electronic device 1600 includes: a processor 1601 and a memory 1602.

The processor 1601 may include one or more processing cores, for example, a 4-core processor or an 8-core processor.

The memory 1602 may include one or more non-transitory computer-readable storage media. The non-transitory computer-readable storage medium may be non-transient. In some embodiments, the non-transitory computer-readable storage medium in the memory 1602 is configured to store at least one instruction. The at least one instruction is used for execution by the processor 1601 to implement the vehicle location sharing method.

In some embodiments, the electronic device 1600 may include: a peripheral interface 1603 and at least one peripheral. The processor 1601, the memory 1602, and the peripheral interface 1603 may be connected through a bus or a signal cable. Each peripheral may be connected to the peripheral interface 1603 through a bus, a signal cable, or a circuit board. The peripheral may include: at least one of a radio frequency circuit 1604, a display screen 1605, a camera assembly 1606, an audio circuit 1607, and a power supply 1609.

The peripheral interface 1603 may be configured to connect the at least one peripheral related to input/output (I/O) to the processor 1601 and the memory 1602.

The radio frequency circuit 1604 is configured to receive and transmit a radio frequency (RF) signal, also referred to as an electromagnetic signal. The radio frequency circuit 1604 communicates with a communication network and other communication devices through the electromagnetic signal.

The display screen 1605 is configured to display a user interface (Ul) The UI may include a graph, text, an icon, a video, and any combination thereof.

The camera assembly 1606 is configured to acquire images or videos.

The audio circuit 1607 may include a microphone and a speaker.

The power supply 1609 is configured to power the various assemblies in the electronic device 1600.

In some embodiments, the electronic device 1600 further includes one or more sensors 1610. The one or more sensors 1610 include, but are not limited to, an acceleration sensor 1611, a gyroscope sensor 1612, a pressure sensor 1613, an optical sensor 1615, and a proximity sensor 1616.

The structure shown in FIG. 16 is merely one example of an electronic device 1600. In other examples, electronic device 1600 may include more or fewer assemblies than illustrated, or some assemblies may be combined, or different assembly arrangements may be employed.

In some examples, a computer device is provided. The computer device may be a terminal or a server as shown in FIG. 2. The computer device includes a processor and a memory. The memory stores at least one instruction, at least one program, a code set, or an instruction set. The at least one instruction, the at least one program, the code set, or the instruction set is loaded and executed by the processor to implement the vehicle location sharing method provided in the foregoing method embodiments.

In some examples, a non-transitory computer-readable storage medium is provided. The non-transitory computer-readable storage medium stores at least one instruction, at least one program, a code set, or an instruction set. The at least one instruction, the at least one program, the code set, or the instruction set is loaded and executed by a processor to implement the vehicle location sharing method provided in the foregoing method embodiments.

In some examples, a computer program product or a computer program is provided. The computer program product or the computer program includes computer instructions. The computer instructions are stored in a non-transitory computer-readable storage medium. A processor of a computer device reads the computer instructions from the non-transitory computer-readable storage medium. The processor executes the computer instructions, so as to enable the computer device to perform the vehicle location sharing method in any of the foregoing embodiments.

The non-transitory computer-readable storage medium may include: a read only memory (ROM), a random access memory (RAM), a solid state drive (SSD), an optical disc, or the like The random access memory may include a resistance random access memory (ReRAM) and a dynamic random access memory (DRAM). The sequence numbers of the foregoing embodiments of this disclosure are merely examples.

What is claimed is:

1. A vehicle location sharing method comprising:
displaying a function interface for providing a location sharing function;
receiving a trigger operation on the location sharing function;
displaying a candidate account list based on the trigger operation, the candidate account list comprising at least one candidate account having an association relationship with a first account, wherein the first account is logged in to an in-vehicle terminal; and
displaying a location sharing result in response to receiving a selection operation on a second account in the at least one candidate account, the location sharing result comprising a result of geographical location information of the in-vehicle terminal shared from the first account to the second account.

2. The method according to claim 1, wherein the in-vehicle terminal comprises a first application with a social function, and the first account is logged in to the first application; and
displaying the candidate account list further comprises:
obtaining the at least one candidate account provided by the social function in the first application based on the trigger operation; and
displaying the candidate account list based on the at least one candidate account.

3. The method according to claim 2, wherein displaying the candidate account list further comprises:
superimposing and displaying a window floating layer on the function interface; and
displaying the candidate account list in the window floating layer based on the at least one candidate account.

4. The method according to claim 2, wherein the in-vehicle terminal further comprises a second application; and
displaying the function interface further comprises:
displaying the function interface in the second application, the function interface comprising a function card provided by the first application, wherein the function card comprises a location sharing control configured to receive the trigger operation.

5. The method according to claim 4, further comprising:
displaying an authorization login interface through which the second application invokes the first application; and
receiving an authorization operation triggered on the authorization login interface to instruct the second application to invoke the first account logged in to the first application for login.

6. The method according to claim 1, wherein receiving the trigger operation further comprises:
receiving a touch operation on the location sharing control displayed on the function interface; or,
receiving a voice input signal used to control the in-vehicle terminal, wherein the voice input signal is used as the trigger operation when the voice input signal comprises a keyword corresponding to the location sharing function.

7. The method according to claim 1, wherein displaying the location sharing result further comprises:
displaying the location sharing result on the location sharing control in response to receiving the selection operation on the second account through a location sharing control; or,
displaying a location sharing interface in response to receiving the selection operation on the second account, the location sharing interface comprising the location sharing result.

8. The method according to claim 7, wherein displaying the location sharing interface further comprises:
displaying a location sharing situation on the location sharing control in response to receiving the selection operation on the second account; and
displaying the location sharing interface in response to receiving a touch operation on the location sharing control.

9. The method according to claim 8, wherein displaying the location sharing interface further comprises:
displaying the location sharing interface in a location sharing vignette of a second application, wherein the location sharing vignette is a service platform in the second application for providing the location sharing function.

10. The method according to claim 7, wherein displaying the location sharing result further comprises:
displaying sharing waiting information on the location sharing control in response to not receiving a sharing acceptance signal of the second account indicating waiting for confirmation of a location sharing message by the second account; or
displaying sharing process information on the location sharing control in response to receiving a sharing acceptance signal of the second account to indicate sharing of the geographical location information of the in-vehicle terminal to the second account.

11. The method according to claim 7, wherein the location sharing interface comprises a sharing account presentation region and a map presentation region; and
displaying the location sharing interface further comprises:
displaying a waiting identity in the sharing account presentation region in response to not receiving a sharing acceptance signal of the second account indicating waiting for confirmation of a location sharing message by the second account, and displaying the geographical location information of the in-vehicle terminal in the map presentation region; or
displaying an account identity of the second account in the sharing account presentation region in response to receiving a sharing acceptance signal of the second account, and displaying the geographical location information of the in-vehicle terminal in the map presentation region, wherein the account identity comprises an identity of a receiving account which receives the geographical location information.

12. The method according to claim 1, wherein displaying the location sharing result further comprises:
receiving a voice input signal to control the in-vehicle terminal; and
determining a second account, having an association relationship with the voice input signal, in the at least one candidate account, and displaying a location sharing result of the second account.

13. The method according to claim 12, wherein before the receiving the voice input signal, the method further comprises:
displaying a voice selection prompt corresponding to each candidate account in the candidate account list, the voice selection prompt indicating a corresponding voice input content during the selection of the candidate account.

14. The method according to claim 1, further comprising:
transmitting a location sharing message to the second account in response to receiving the selection operation on the second account, wherein the location sharing message comprises a location sharing link and provides an entry of a location sharing applet, hosted by a first application, to the second account.

15. The method according to claim 1, wherein after displaying the location sharing result, the method further comprises:
ending location sharing between the first account and the second account in response to a location sharing process satisfying a termination condition.

16. The method according to claim 15, wherein the ending location sharing further comprises:
ending location sharing between the first account and the second account in response to the first account logging out in a first application; or,
ending location sharing between the first account and the second account in response to stalling and power failure of a vehicle corresponding to the in-vehicle terminal; or,
ending location sharing between the first account and the second account in response to receiving a location sharing termination operation; or,
ending location sharing between the first account and the second account in response to a location obtaining failure state lasting for a threshold duration.

17. A vehicle location sharing apparatus comprising:
a memory, the memory storing computer-readable instructions for vehicle location sharing; and
a processor in communication with the memory, the processor configured by the computer-readable instructions to:
display a function interface for providing a location sharing function;
receive a trigger operation on the location sharing function;
display a candidate account list based on the trigger operation, the candidate account list comprising at least one candidate account having an association relationship with a first account, wherein the first account is logged in to an in-vehicle terminal; and
display a location sharing result in response to receiving a selection operation on a second account in the at least one candidate account, the location sharing result comprising a result of geographical location information of the in-vehicle terminal shared from the first account to the second account.

18. A non-transitory computer-readable storage medium, comprising processor executable instructions for performing a vehicle sharing method, the processor executable instructions, when executed by a processor, configured to cause the processor to:
display a function interface for providing a location sharing function;
receive a trigger operation on the location sharing function;
display a candidate account list based on the trigger operation, the candidate account list comprising at least one candidate account having an association relationship with a first account, wherein the first account is logged in to an in-vehicle terminal; and
display a location sharing result in response to receiving a selection operation on a second account in the at least one candidate account, the location sharing result comprising a result of geographical location information of the in-vehicle terminal shared from the first account to the second account.

19. The non-transitory computer-readable storage medium according to claim 18, further comprising processor executable instructions for causing the processor to:
receive a touch operation on the location sharing control displayed on the function interface; or,
receive a voice input signal used to control the in-vehicle terminal, wherein the voice input signal is used as the trigger operation when the voice input signal comprises a keyword corresponding to the location sharing function.

20. The non-transitory computer-readable storage medium according to claim 18, further comprising processor executable instructions for causing the processor to:
receive a voice input signal to control the in-vehicle terminal; and
determine a second account, having an association relationship with the voice input signal, in the at least one candidate account, and displaying a location sharing result of the second account.
